(19) United States
(12) Patent Application Publication
(10) Pub. No.: US 2002/0042720 A1
(43) Pub. Date: Apr. 11, 2002

(54) System and method of displaying comparative advertising on the internet

(76) Inventors: Lawrence Taylor JR., Eagle River, AK (US); Chris R. Curry, Anchorage, AK (US)

Correspondence Address: Lawrence Taylor, Jr., P.O. Box 772048, Eagle River, AK, 99577, US

(21) Appl. No.: 09/968,271

(22) Filed: Oct. 1, 2001

Related U.S. Application Data
(60) Provisional application No. 60/239,168, filed on Oct. 9, 2000.

(51) Int. Cl. G06F 17/60

(52) U.S. Cl. 705/1; 345/700

(57) ABSTRACT

A novel system and method is provided for displaying files over a local area network or over the Internet. It is appropriate for displaying either hierarchical information or comparative information either within a company or government entity or within vertical markets. The method includes the steps of defining headings for either non-comparative information or comparative information within any company or government entity or within any vertical market, listing either hierarchical information or the products or services of vendors in a vertical market, including vendors that do not have a Web presence, allowing vendors to enter the information defined by the headings, allowing vendors to enter descriptions differentiating products or services in their market, allowing clients to research products or services, and providing a means of soliciting products or services not listed. The step of displaying files eliminates the wait for successive server round trips after the first server round trip, saving client time. The method includes displaying the files on the home page, preventing client confusion.

### BACKGROUND

1. Field of the Invention

This method relates to Internet displays, specifically, this method relates to an improved method of displaying comparative advertising via the Internet.

2. Description of Prior Art

There is background for a first problem. It is difficult and expensive for vendors to advertise effectively on the Internet. This applies particularly to vendors who want to display a description of their technical capabilities to allow them to differentiate themselves in their vertical markets in comparison with others in that vertical market.

There is background for second and third problems in the prior art: “System and Method for Finding Product and Service Related Information on the Internet” (Thomas J. Perkowski, U.S. Pat. No. 5,918,214, Jun. 29, 1999). This method links preassigned Uniform Resource Locators to products and services. (Note: This is not a universal resource locator (URL), a term commonly used in the art to refer to the Internet address of a Web site, rather than to a specific product or service as described in Perkowski.) If a product is on the Internet and has a Uniform Resource Locator, its information is available. This presents the second problem: clients are presented only with one product or service at a time; they do not have the choice of viewing alternative products or services at the same time. This also presents the third problem: information is accessible only if it is already on the Internet.

There is background for a fourth problem in the prior art: “Virtual Catalog and Product Presentation Method and Apparatus” (Charles E. Hill, U.S. Pat. No. 5,970,471, Oct. 19, 1999). This method displays product images in a comparative format. An image description is available. This presents the fourth problem: there is no support for complex written comparative information to differentiate products or services.

As background for a fifth problem, in none of the above referenced prior art is there accommodation for products or services not found. This presents a fifth problem: no accommodation is made in the prior art for requesting information not found.

There is background for a sixth problem. On virtually any Web site that presents information, the client is offered links to more information about each selection. Selecting any of those links takes the client away from the home page of the Web site, sometimes through many levels, to view the information. This presents a sixth problem: it can be difficult to navigate to, and back from, the information of interest.

There is background for a seventh problem in the prior art. A client can instruct any commonly used search engine to find information on the Internet. The relevant list of Web sites is presented in a report on the computer screen. The first page of the report downloads in response to the search instruction. The report may include pages in addition to the first page. The additional pages, or files, are listed in the report as numbers, “1, 2, 3,” etcetera. Each page is information that downloads when the client clicks on its listed number. Each click signals the Web server, the Web server signals the client computer, and they establish a connection. Then the computers interact to transfer the information request and provide the information requested. The time from the client click to the Web server response is called the server round trip. The wait for the server round trip is called the latency period. For each latency period, establishing the connection may take most of the time. This presents the seventh problem: clients must wait during the latency period before viewing the requested information. The wait for the latency period can be experienced by performing a search on the U.S. Patent and Trademark Office Web site and clicking on the successive pages listed, but only from outside of the USPTO. Inside the USPTO, the response will have no delay. Therefore, USPTO clerks will have to use a public search engine, like Yahoo.com, to generate a search with successive page numbers listed and then click on those page numbers in succession to experience the wait for the latency period after each click.

### SUMMARY

The present system provides a method of selecting and displaying electronic files. The files are categories of product or service advertisements. The files may be from vendors on the Internet or from those without an Internet presence. The files are stored in a vendor database. A phrase in a marquee category file represents each stored file. The phrases are displayed in a scrolling marquee display. A client selects a phrase with a client feedback tool. The associated file is presented in a grid display in a comparison format. The file is presented using threads of a Java applet rather than a full process. This avoids the delay of a server round trip. The system offers an inquiry for products or services not found. The method is easy to navigate because it allows information selection and presentation without leaving the home page of the Web site.

### Objects and Advantages

Accordingly, several objects and advantages of our method are:

1) Vendors are able to include information to differentiate themselves in their vertical markets.

2) Complex, comparative choices of product or service descriptions can be presented. These may include alternatives outside of the client's initial understanding. Thus, clients might recognize a connection between ideas that is not at first obvious. This allows more careful consideration before a decision than might otherwise be the case.

3) Products and services not available on the Internet can be listed.

4) Complex technical descriptions of products or services are allowed.

5) Clients can request listings of products or services not found without having to continue their search on other Web sites, where the product or service might not be available.

6) Information is displayed without having to leave the home page of the Web site, thus obviating navigation difficulties in finding files of interest.

7) After the first file is displayed, all files can be displayed without waiting for the latency period.

Other objects and advantages are as follows. This method allows vendors to advertise complex technological products or services, in their own vertical market, in a simple, inexpensive format. A vertical market is any aggregation of vendors and their clients of one type or class of product or service, such as laboratory testing, pharmaceuticals, travel, stocks and bonds, or bulk chemicals, and including all markets as they would commonly be delineated in a telephone yellow pages directory. This method allows a column for vendor-defined descriptions. This method allows vendors to present photographs, movies, writings, products, or services. This method allows vendors without a Web site to advertise on the World Wide Web. This method allows vendors with a Web site, but with their advertising buried deep within the Web site, to advertise on the first page of a Web site, or a home page. This method allows clients to compare products and services with categories such as price, location, and description. This method allows the Web architect to change column headings to provide consistency of information presented in any single vertical market. This method presents vendor contact to their clients through telephone, letter, fax, e-mail, or URL link. Further objects and advantages will become apparent from the drawings and ensuing description.

### DRAWING FIGURES

In the drawings, closely related figures have the same number but different alphabetic suffixes.

FIG. 1 is a schematic diagram of a first illustrative embodiment of the present method consisting of a client computer, a Web server, and a vendor computer connected through an Internet infrastructure and an e-mail carrier.

FIG. 2 is a schematic representation of a conventional Web site presented on a client computer. On the client computer is an Internet browser with Java virtual machine, a marquee display, and a grid display. Also on the screen are buttons titled “Request for products or services not found” and “Vendor update.” On the marquee display is a multiplicity of hotzones and within each hotzone is a marquee category. In addition, the arrow illustrated pointing to one of the categories in one hotzone is a client feedback tool. On the grid display are one of a multiplicity of grid display headings, one of a multiplicity of column headings, and one of a multiplicity of detail rows.

FIG. 3A is a schematic diagram illustrating the high level structure of a protocol for communication between the client computer and the Web server that each use to communicate with the other through the Internet. The client computer contains the browser, a client feedback motion tool motion message, a marquee display thread, a newly selected hotzone message, and a grid display thread. The Web server contains an HTML static document and Java codebase, an HTTP server process, a server process that responds to client computer requests, and a vendor database.

FIG. 3B is a schematic diagram illustrating the operational steps of the communication protocol in FIG. 3A.

FIG. 3C is a high level flow chart explaining the operational steps involved in carrying out the communication protocol shown in FIG. 3B.

FIG. 4A is a schematic diagram illustrating the high level structure of a protocol for communication between the vendor computer and the Web server computer each communicating with the other through the Internet. The vendor computer contains the browser and the HTML vendor forms. The web server contains the Java codebase, the server process, the server process that responds to vendor computer requests, and the vendor database.

FIG. 4B is a schematic diagram illustrating the operational steps of the communication protocol in FIG. 4A.

FIG. 4C is a high level flow chart explaining the operational steps involved in carrying out the communication protocol shown in FIG. 4B.

FIG. 5A is a schematic diagram illustrating the high level structure of a protocol for communication between the client computer and the vendor computer with the Web server as intermediary. The client computer and the vendor computer communicate with the Web server through the Internet. In addition, the Web server communicates with the vendor computer through the e-mail carrier. The client computer consists of the browser, an HTML request forms, and an e-mail. The vendor computer consists of the browser and an HTML response forms. The Web server consists of the Java codebase, the server process, an e-mail request database maintenance server, an e-mail database, and the vendor database.

FIG. 5B is a schematic diagram illustrating the operational steps of the communication protocol in FIG. 5A.

FIG. 5C is a high level flow chart illustrating the steps involved in carrying out the communication protocol shown in FIG. 5B.

### REFERENCE NUMERALS IN DRAWINGS

### Part Number Description In figures

20 First illustrative embodiment of the present method 1

22 Internet Infrastructure 1,3a-b, 4a-b , 5a-c

24 Web server 1,3a-c ,4a-b , 5a-b

26 Client computer 1,2, 3a-c , 5a-b

28 Vendor computer 1,4a-b,5a-c

30 Java applet 3a-c

32 Grid display thread 3a-c

34 Newly selected hotzone message 3a-c

36 Marquee display thread 3a-c

38 Client feedback motion tool motion message 3a-b

40 Internet browser with Java virtual machine 2, 3a-c , 4a-b, 5a

42 HTML static document and Java codebase 3a-c , 4a-c, 5a

44 HTTP server process 3a-c , 4a-c, 5a-c

46 Server process that responds to client computer requests 3a-c

48 Vendor database 3a-c , 4a-c, 5a-c

50 Server process that responds to vendor computer requests 4a-c

52 HTML vendor forms 4a-c

54 HTML request forms 5a-c

56 e-mail 5a-c

58 e-mail carrier 1, 5a-b

60 HTML response forms 5a-c

62 e-mail request database maintenance Server 5a-c

64 e-mail database 5a-c

66 Marquee display 2

68 Grid display 2, 3c

70 Hotzone 2, 3c

72 Detail row 2, 3c

74 Request for product or services not found 2, 5c

76 Vendor update 2

78 Column heading 2

80 Headings for grid display 2

82 Marquee category 2, 3c

84 Client feedback tool 2, 3c

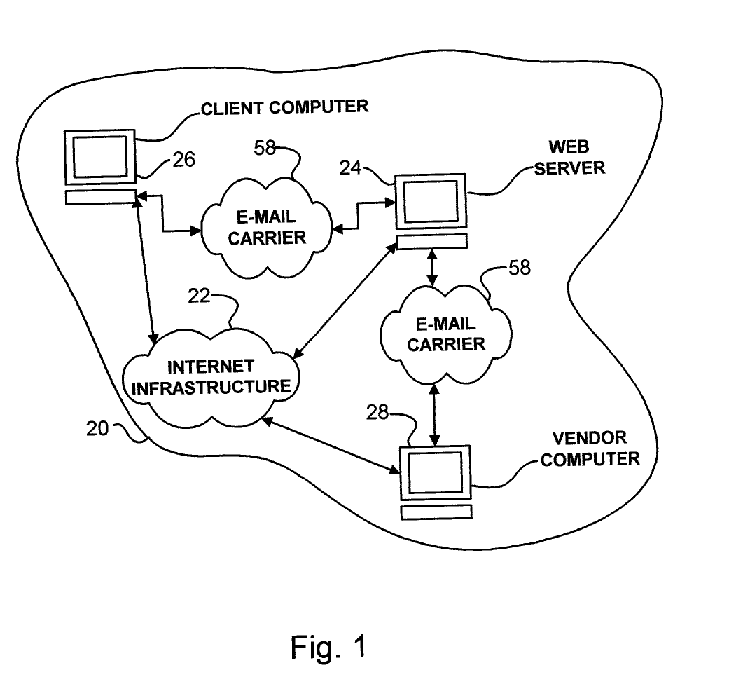

### DESCRIPTION—FIGS. 1 through 5—Main Embodiment

FIG. 1 is a schematic diagram of a first illustrative embodiment of a system and method of displaying comparative advertising 20. It shows the basic idea of the present method. The present method comprises an arrangement of components, namely: one of a multiplicity of client computers 26, connected through an Internet infrastructure 22, to a Web server 24, providing advertising. When there is communication, the telecommunication protocol could be HTTP, TCP/IP sockets, or XML. The preferred method of the present embodiment is HTTP. The advertising is submitted to the Web server by one of a multiplicity of vendor computers 28 through the Internet. There is also communication between the client computer and the Web server through an e-mail carrier 58 and between the vendor computer and the Web server through the e-mail carrier.

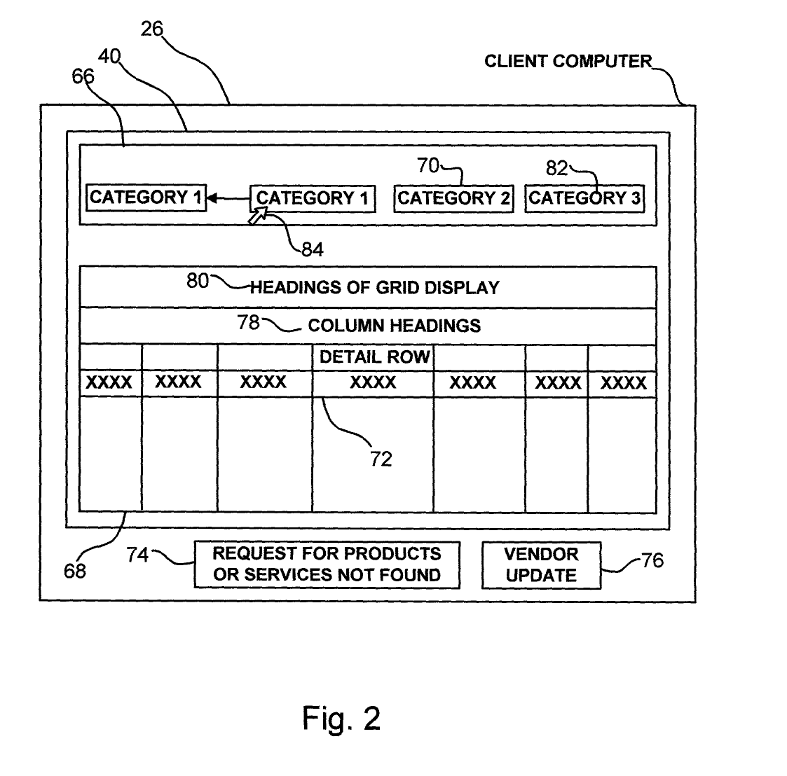

FIG. 2 is a schematic representation of client computer 26. Represented on a conventional client computer screen (not shown in detail other than as the client computer) are an Internet browser with Java virtual machine 40, a marquee display 66, and a grid display 68. Also on the screen is a request for products or services not found button 74, and a vendor update button 76. On the marquee display are three of a multiplicity of hotzones 70, and, within each of the hotzones, is a marquee category 82, which can also be called a phrase. The hotzone may consist of, but is not limited to, text, raster graphics, or buttons. These are common iconic visual representations of client interface controls. There is an arrow pointing from marquee category 1 to another hotzone, also named marquee category 1. This represents movement. The movement may be in any direction or manner, such as bouncing, or it may be holding still if there are few enough categories to be displayed without motion. The preferred movement is scrolling of the hotzones and their attendant marquee categories from right to left. In addition, pointing to one of the categories in one of the hotzones is represented a client feedback tool 84. The client feedback tool tells a client where he or she is on the Web site. Client feedback tools may consist of, but are not limited to, cursors, arrows, or pens, but are here called cursors. On grid display 68 are a headings for grid display 80, a column headings 78, and a detail row 72, consisting of a series of X's within separate columns on one of a multiplicity of the detail rows.

Column headings may be represented by any other type of information designator, such as color, position, or symbol.

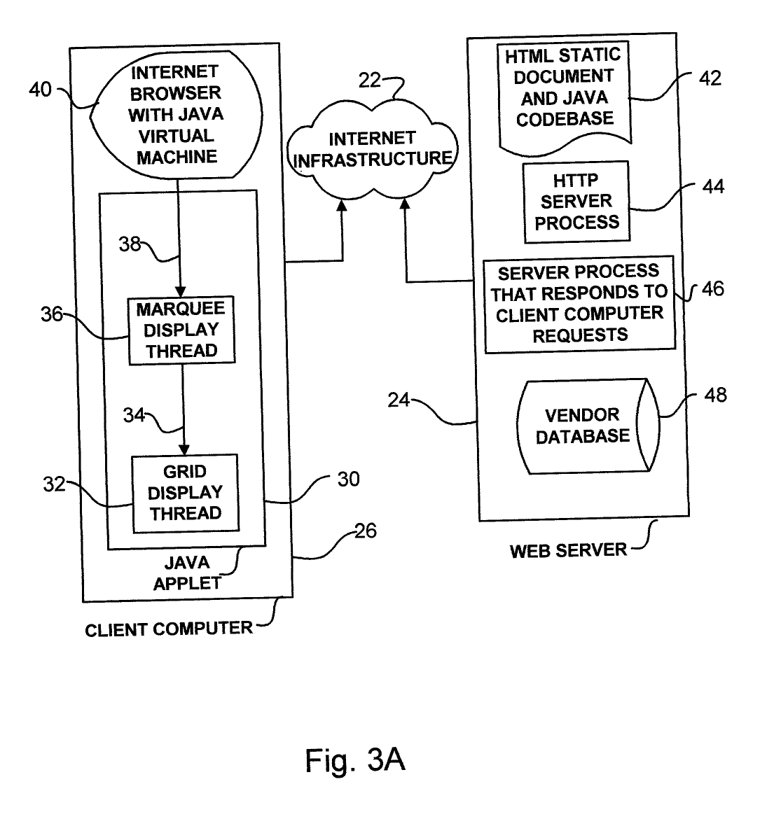

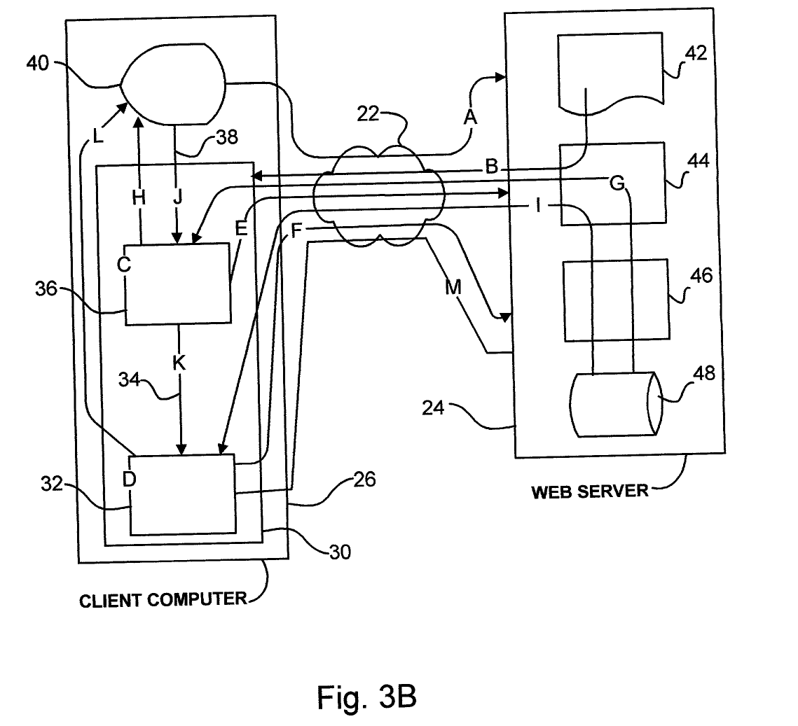

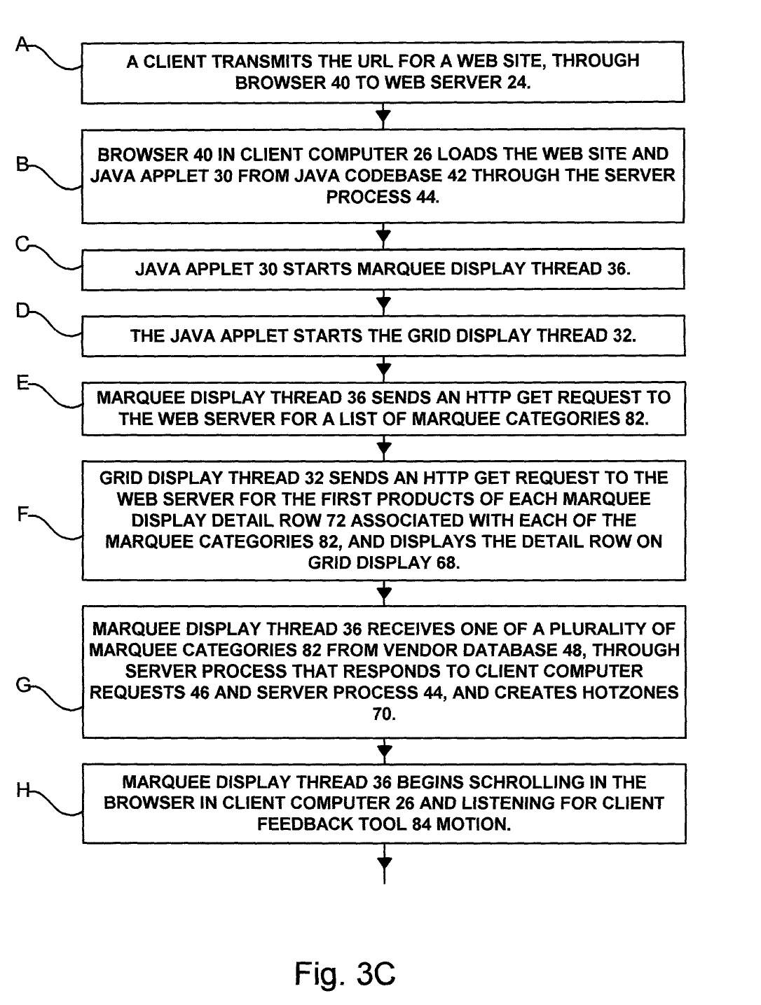

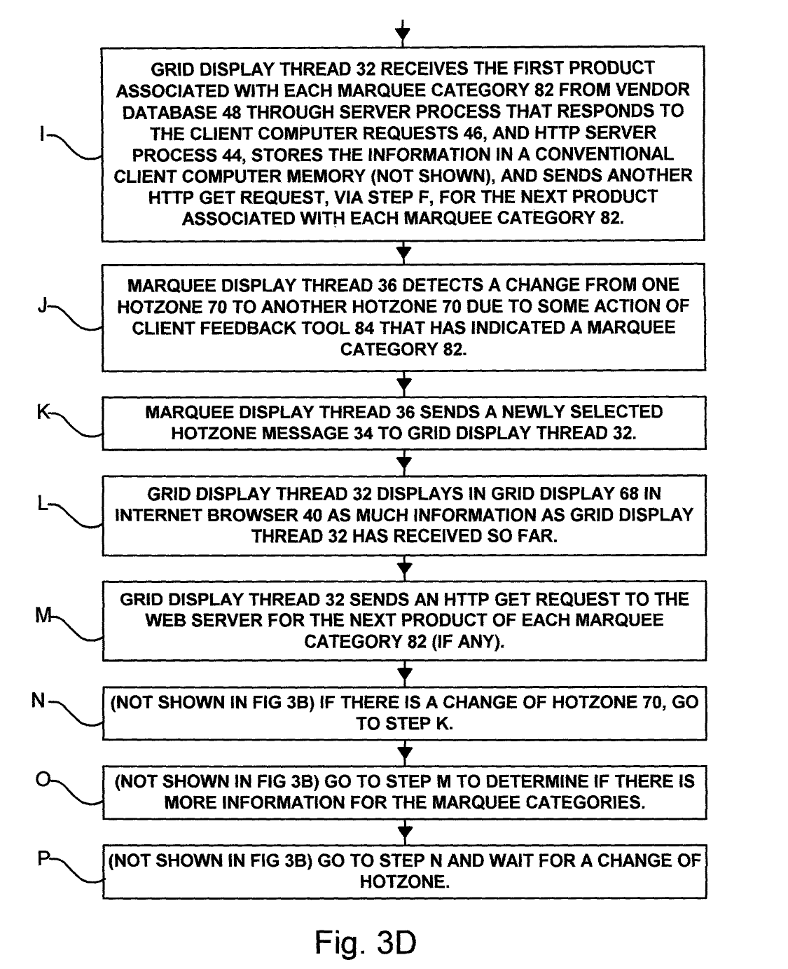

FIG. 3A is a schematic diagram illustrating the high level structure of a protocol for communication between client computer 26 and Web server 24. The client computer and the Web server communicate through infrastructure 22. The client computer contains browser 40 and a Java applet 30. The applet could also be JavaScript, DHTML, ActiveX, or VB script. When the browser is used in the present embodiment, if the pages use other technologies, the browser may not have to include Java. Within the applet is a marquee display thread 36 and a grid display thread 32. The marquee display thread interacts with the browser through a client feedback motion tool motion message 38. The grid display thread interacts with the marquee display thread through a newly selected hotzone message 34. Web server 24 contains HTML static document and Java codebase 42, an ITTP server process 44, a server process that responds to client computer requests 46, and a multiplicity of common information files (not shown) in a vendor database 48. The preferred embodiment includes HTML forms, but they could also be Java applets, DHTML, JavaScript, ActiveX, or VB script. The server processes of the preferred embodiment may or may not be integrated with the main HTTP server process, they may use any number of threads of processing, they may be scripting or compiled code, they may run interactively with the server desktop or as a service or daemon. The server processes may even run on a different physical machine and use RMI, RPC, or other methods to run distributed.

FIG. 3B illustrates the operational steps of the protocol in FIG. 3A.

FIG. 3C and its continuation in FIG. 3D explain the illustration in FIG. 3B, as follows. In step A, the client transmits the URL for a Web site, through the browser in the client computer, to the Web server. In step B, browser 40 in client computer 26 loads the Web site and Java applet 30 from Java codebase 42 through the server process 44. In step C, the Java applet starts marquee display thread 36. In step D, the Java applet starts the grid display thread 32. In step E, marquee display thread 36 sends an HTTP GET request to the Web server for a list of marquee categories 82. In step F, grid display thread 32 sends an HTTP GET request to the Web server for the first products of each marquee display detail row 72 associated with each of the marquee categories 82, and displays the detail row on grid display 68. In step G, marquee display thread 36 receives one of a plurality of marquee categories 82 from vendor database 48, through server process that responds to client computer requests 46 and server process 44, and creates hotzones 70. In step H, marquee display thread 36 begins scrolling in the browser in client computer 26 and listening for client feedback tool 84 motion. In step I, grid display thread 32 receives the first product associated with each marquee category 82 from vendor database 48 through server process that responds to the client computer requests 46, and HTTP server process 44, stores the information in a conventional client computer memory (not shown), and sends another HTTP GET request, via step F, for the next product associated with each marquee category 82. In step J, marquee display thread 36 detects a change from one hotzone 70 to another hotzone 70 due to some action of client feedback tool 84 that has indicated a marquee category 82. Client action can be movement of a mouse or use of the tab key on the client computer. In step K, marquee display thread 36 sends message 34 to grid display thread 32. In step L, grid display thread 32 displays in grid display 68 in browser 40 as much information as grid display thread 32 has received so far. In step M, grid display thread 32 sends an HTTP GET request to the Web server for the next product of each marquee category 82 (if any). In step N (not shown), if there is a change of hotzone 70, go to step K. In step O (not shown), go to step M to determine if there is more information for the marquee categories. In step P (not shown), go to step N and wait for a change of hotzone.

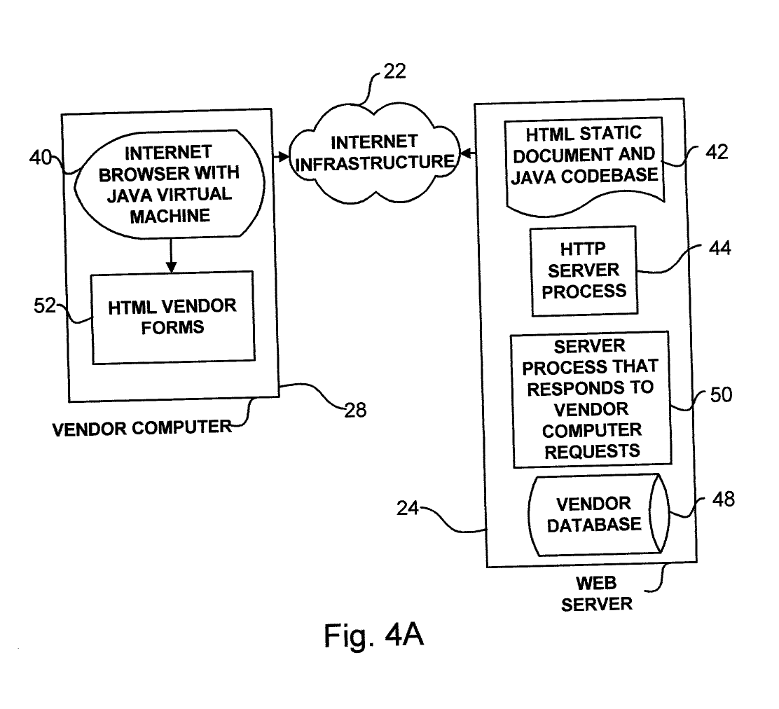

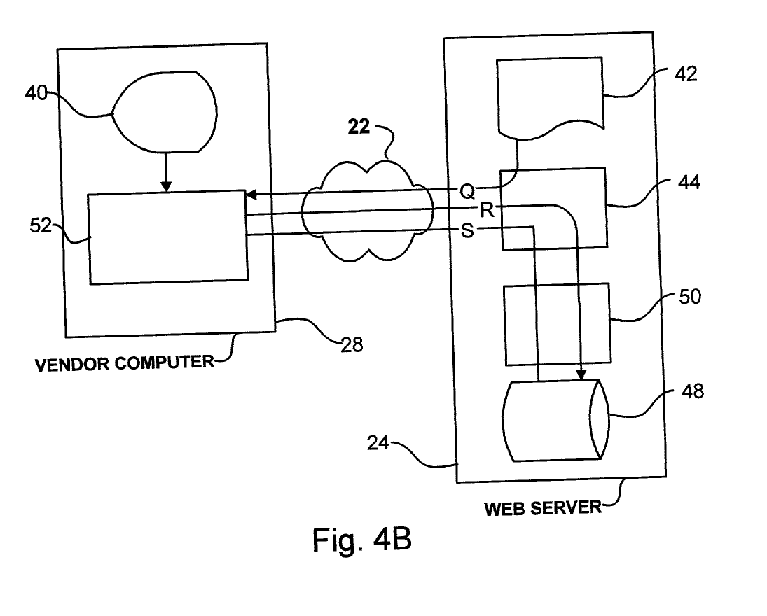

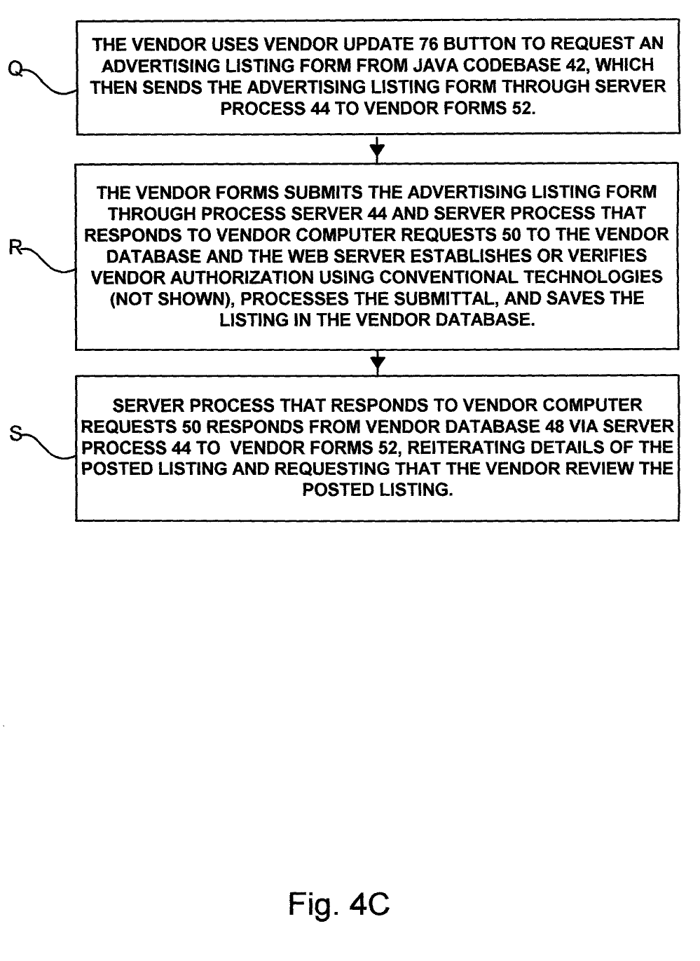

FIG. 4A is a schematic diagram illustrating the high level structure of a protocol for communication between vendor computer 28 and Web server 24. Vendor computer 28 and Web server 24 communicate through Internet infrastructure 22. Vendor computer 28 contains browser 40 and an HTML vendor forms 52. The Web server contains Java codebase 42, server process 44, server process that responds to vendor computer requests 50, and vendor database 48.

FIG. 4B illustrates the operational steps of the protocol in FIG. 4A.

FIG. 4C explains the illustration in FIG. 4B, as follows. In step Q, the vendor uses vendor update 76 button (in FIG. 2) to request an advertising listing form from Java codebase 42, which then sends the advertising listing form through server process 44 to vendor forms 52. In step R, the vendor forms submits the advertising listing form through server process 44 and a server process that responds to vendor computer requests 50 to the vendor database and the Web server establishes or verifies vendor authorization using conventional technologies (not shown), processes the submittal, and saves the listing in the vendor database. In step S, server process that responds to vendor computer requests 50 responds from vendor database 48 via server process 44 to vendor forms 52, reiterating details of the posted listing and requesting that the vendor review the posted listing.

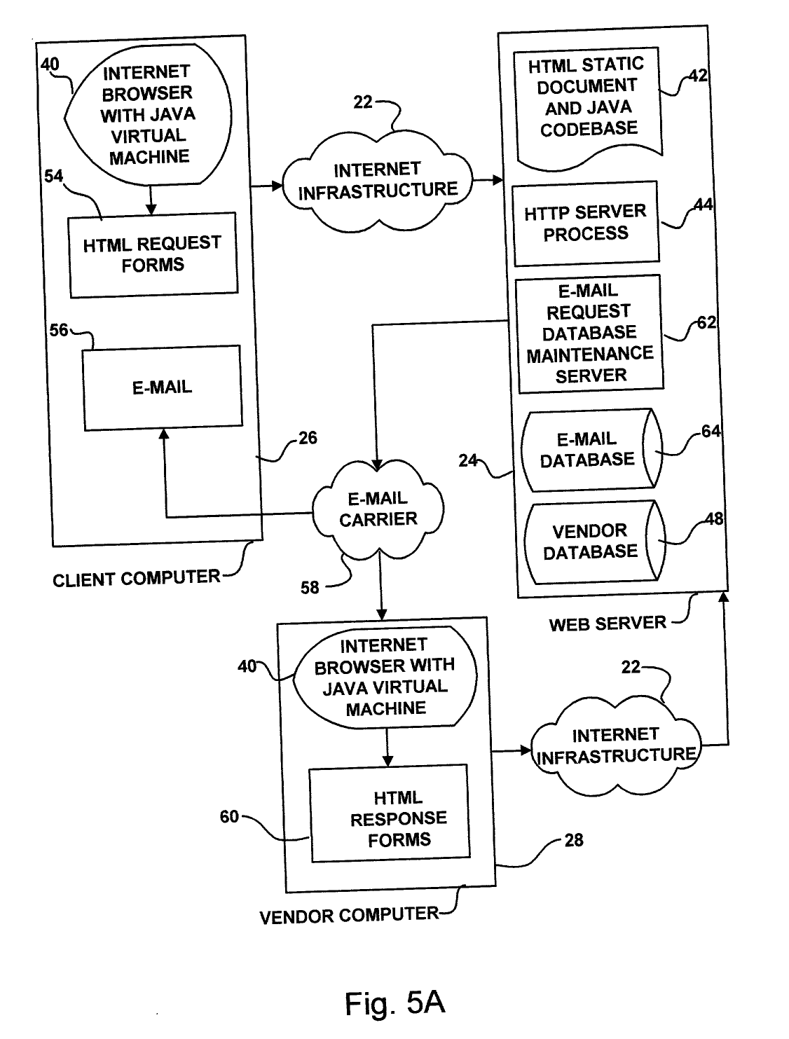

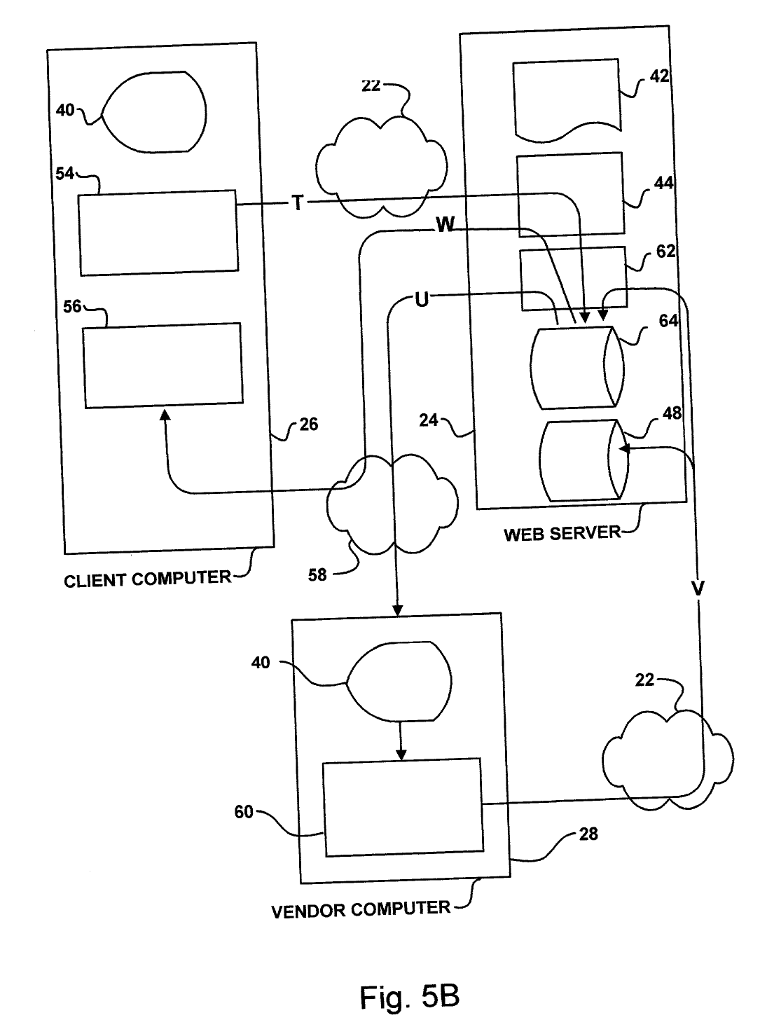

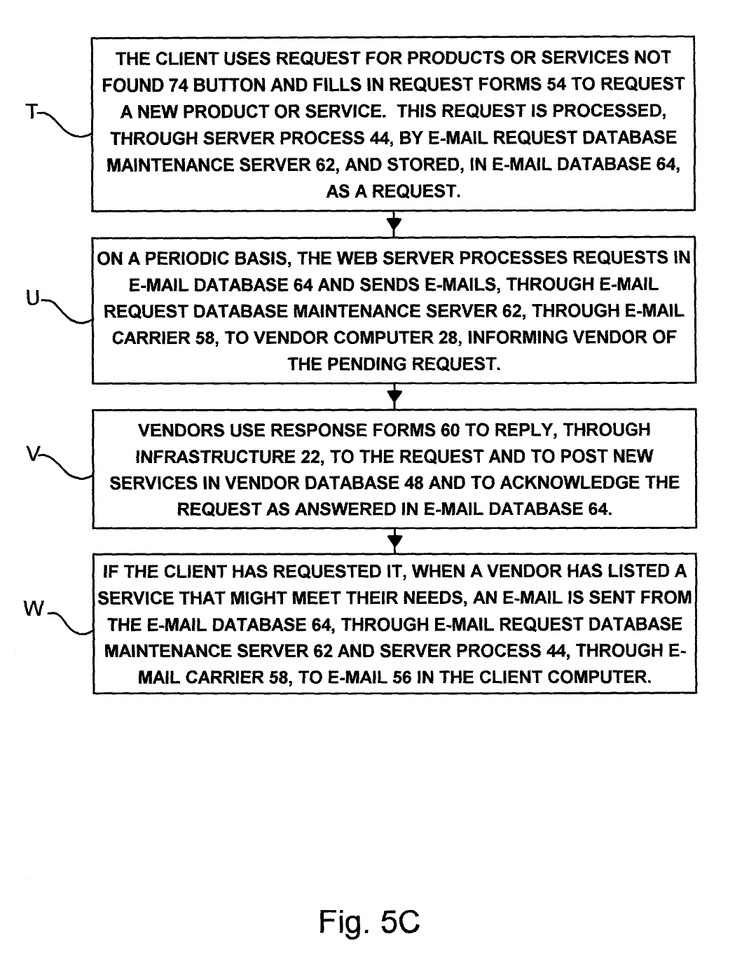

FIG. 5A is a schematic diagram illustrating the high level structure of a protocol for communication between the vendor computer and the Web server, and between the client computer and the Web server. The client computer contains browser 40, an HTML request forms 54, and an e-mail 56. The Web server contains Java codebase 42, server process 44, an e-mail request database maintenance server 62, an e-mail database 64, and vendor database 48. The vendor computer contains browser 40, and an HTML response forms 60. When in the preferred embodiment there is a database, information may be stored under the control of some other software or may be stored as plain text files in the native operating system format. The client computer and the Web server communicate through infrastructure 22 and e-mail carrier 58. The vendor computer and the Web server communicate through both infrastructure 22 and e-mail carrier 58.

FIG. 5B illustrates the operational steps of the protocol in FIG. 5A.

FIG. 5C explains the illustration in FIG. 5B, as follows. In step T, the client uses request for products or services not found 74 button (in FIG. 2) and fills in request forms 54 to request a new product or service. This request is processed, through server process 44, by e-mail request database maintenance server 62, and stored, in e-mail database 64, as a request. In step U, on a periodic basis, the Web server processes requests in e-mail database 64 and sends e-mails, through e-mail request database maintenance server 62, through e-mail carrier 58, to vendor computer 28, informing the vendor of the pending request. In step V, vendors use response forms 60 to reply, through infrastructure 22, to the request and to post new services in vendor database 48 and to acknowledge the request as answered in e-mail database 64. In step W, if the client has requested it, when a vendor has listed a service that might meet their needs, an email is sent from the e-mail database 64, through e-mail request database maintenance server 62 and server process 44, through e-mail carrier 58, to e-mail 56 in the client computer.

### Advantages

From the description above, a number of advantages of our System and Method of Displaying Comparative Advertising on the Internet become evident:

1) When a client changes marquee categories, there will be a shorter wait than on Web sites not using this technology for the selected information to be viewed in the grid display, saving time.

2) When a client changes marquee categories, the client will not leave the home page, simplifying navigation.

### Operation—FIGS. 1 through 5

The operation of this method is explained in detail from the description above.

### Easy and Inexpensive Vendor Advertising

The first aspect of the present method is the provision of an inexpensive listing service that is easy for vendors to use to differentiate themselves. This is made possible with the present method by automating communications that allow the aggregation in any vertical market of all vendors advertising in that market.

### Comparative Display

The second aspect of the present method provides a comparison format in grid display 68. In addition, the present method provides a model for displaying comparative information using column headings 78. The column headings can be changed for consistency of information within any vertical market. Consider the laboratory testing market as an example. Marquee categories 82 such as “analytical, environmental, forensic, and medical,” take the place of “1, 2, 3,” etcetera used, in the Background—Description of Prior Art, as report designators. Within the reports represented by these marquee categories 82, column headings 78 organize comparative information. Column headings such as test name, price, substance tested, laboratory name, and accreditation are used. There is also an open “test description” heading. A client, considering test descriptions under the marquee category “analytical” testing, may learn of a new test. The client may thus gain knowledge to refine his or her choice by reviewing tests in addition to those about which they are already familiar.

### Products or Services Not Available on the Internet Can Be Listed

The third aspect of the present method supports the listing of products or services not available on the Internet. This is done by soliciting listings from vendors that do not have a Web presence. This is fully described under the fifth aspect of the present method.

### Space Available for Sufficient Information to Make a Decision

The fourth aspect of the present method solves the problem of not providing sufficient information to make a decision. To accomplish this, the present method gives vendors space for descriptions sufficient to differentiate their products or services in their market.

### Accommodation for Products or Services Not Found

The fifth aspect of the present method initiates a request for products or services not found 74. In the laboratory testing vertical market, this is a Request for Tests Not Found. A client submits a Request for Tests Not Found on the Web server. The Web server sends an e-mail solicitation report to vendors with the Request for Tests Not Found. If a vendor then lists the requested test, Web server 24 so notifies the client via e-mail 56. The email solicitation report suggests to vendors who are not able to provide a requested test that they forward the solicitation by e-mail to other possible vendors. Other possible vendors include those that do not have a Web presence, as under the third aspect of the present method, above.

### No Navigation To or From the Information of Interest

The sixth aspect of the present method allows the client to stay on the home page while requesting information and reviewing the results of that request.

### The Wait for the Latency Period is Resolved

The seventh aspect of the present method resolves the problem of the wait for the latency period. A plurality of marquee categories 82, such as “1, 2, 3,” etcetera, represents page numbers, or files, of a report. Each marquee category is presented by a single thread of a multi-threaded Java applet, specifically, a marquee display thread 36. This presentation is made in a first display area on a Web site. The first display area is a marquee display 66. The marquee display contains a plurality of moving geometric regions in a plurality of hotzones 70. The hotzones in the marquee display scroll continuously. Thus, more hotzones than fit on the marquee display are presented on the Web site. Clients indicate a hotzone by moving client feedback tool 84 into the hotzone. A second display area is a grid display 68. When the client indicates one of the marquee categories in marquee display 66, the associated grid display thread 32 presents the file in the grid display.

The seventh aspect of the present method saves time. It does so using threads of a Java applet rather than a full process. A process is an execution path through one or more programs. The process has an execution start and a dispatching priority. The unit of dispatching is usually referred to as a thread or a lightweight process. The advantages of threads over processes are: (1) It takes less time to create a new thread than a process. This is because the newly created thread uses the current process address space. (2) It takes less time to terminate a thread than a process. (3) It takes less time to switch between threads within the same process address space. This is because the newly created thread uses the current processing address space. (4) There is less communication because the threads of one process share address space. Therefore, data produced by one thread is immediately available to all other threads.

Thus, the first file downloads in response to the search instruction. In the background, other threads of the Java applet download the remaining files. The client indicates marquee category 82 by moving client feedback tool 84 within its hotzone 70. One thread highlights marquee category 82. Another thread responds by displaying the information related to the indicated marquee category. The sequence requires zero clicks. The client does not have to click on the marquee category to download the information. The information begins to display, avoiding the latency period of successive server round trips after the initial round trip. The client does not have to leave the site's home page.

To describe the operation of the seventh aspect completely, the System and Method of Displaying Comparative Advertising on the Internet process follows these steps: 1) a client enters the URL for a Web site; 2) the client browser 40 loads the Web site and Java applet; 3) the Java applet starts the marquee display thread 36; 4) the Java applet starts the grid display thread 32; 5) the marquee display thread 36 sends an HTTP GET request to the Web server 24 for the list of marquee categories 82; 6) the grid display thread sends an HTTP GET request to the Web server for the first products of each marquee category; 7) the marquee display thread receives the marquee categories, creates hotzones, begins scrolling and listening for feedback tool 84 motion; 8) the grid display thread receives the first products for each marquee category, stores the information in the client computer memory, and sends another HTTP GET request for the second product of each marquee category; 9) the marquee display thread detects a change of hotzone (due to some action by the client) and sends a change of hotzone message to the grid display thread; 10) the grid display thread receives the message from the marquee display thread; 11) the grid display displays as much information as it has on the requested marquee category; 12) the grid display thread sends an HTTP GET request to the Web server for the next products of each marquee category (if any); 13) if there is a change of hotzone, go to step 9; 14) if there is more information for the marquee categories, go to step 12; 15) Wait until there is a change of hotzone, then go to step 9.

### Conclusion, Ramifications, and Scope

The System and Method of Displaying Comparative Advertising on the Internet is a useful service to advertisers. It also provides to their clients a fundamental information resource and timesavings. This system allows a client to immediately begin to display files offered on a Web site. This obviates the wait for successive latency periods after the first HTTP GET request is completed. It provides a method of presenting to clients a broad comparative choice of any information, including that of products or services. This allows clients to learn more about their field of inquiry. It provides a method of listing products and services not available on the Internet. It provides comparative information to make a decision. It provides a request for information not found. It allows vendors to differentiate themselves in their vertical market.

A first application of this system would be putting the current hard copy of all yellow pages business telephone directories on the Internet and enabling the customer to view any product or service in a comparison format. A second application of this system would be putting the catalogues of all business vendors for a company or government entity on an intranet, or local area network, and enabling representative of that entity to view any products or services available to that entity in a comparison or non-comparison format, thus facilitating company or government entity procurement. A third application of this system would be as a mechanism to organize and display hierarchical information in a non-comparative or comparative listing, such as of phone numbers of different categories of business or government entity contacts.

The above description contains much specificity. This should not limit the scope of the method. It is, rather, an exemplification of one preferred embodiment. Many other variations are possible. The marquee can be in any number of frames or presented on separate screens. The display can be in any number of frames or separate screens. The files displayed could be photographs, movies, writings, or product or service information.

Accordingly, the scope of the method should be determined not by the embodiment illustrated, but by the appended claims and their legal equivalents.

What is claimed is:

1. In combination, a method of displaying a plurality of electronic files and a means for minimizing the latency period caused by successive server round trips, comprising:
providing said plurality of electronic files, consisting of written documents, photographs, movies, spreadsheets, database reports, or any other electronic file that conveys information, in a database, such as a vendor database,
providing a marquee category file consisting of a plurality of phrases each associated with one of the plurality of electronic files;
a first means of displaying on an electronic screen a first display, or marquee display, displaying said marquee category file so that said plurality of phrases move so that more than can fit within said marquee display can be viewed;
a second means of indicating any one of the plurality of phrases in the marquee display;
a third means of presenting on said electronic screen a second display, or grid display, for the presentation of any one of the plurality of electronic files selected by said means of indicating any of the plurality of phrases in the marquee display;
a fourth means of presenting in said grid display, in a comparison format, the information in any one of the plurality of electronic files; and
a fifth means of minimizing the experience of successive server round trips when the means of indicating any one of the plurality of phrases in the marquee display results in the electronic file being presented on the electronic screen by any method, such as using threads of a Java applet,
whereby a person can review listings of information, such as categories of internal company or government entity phone numbers, or desired products or services on a common local area network or on the Internet without leaving the home page of any Web site that uses the present method and minimizing the experience of the latency periods subsequent to the first round trip, and
whereby a Web site can provide either a free or a fee based listing service that is a business directory for all products and services, like a yellow pages on the Internet with the additional function of being able to sort listings and display them either in a non-comparison or in a comparison format.

2. The method and means of claim 1, further comprising providing the vendor database for files from vendors that either do or do not have a Web presence.

3. The method and means of claim 1, further comprising a request servicing means for servicing a request made using a request for products or services not found by a client, wherein said request is transmitted to those vendors that have agreed to receive the request in the form of a solicitation from a Web server, and wherein those vendors able to advertise the solicited product or service can list that product or service with said Web server in exchange for compensation or, in the case of a business or government entity's local area network, without compensation as an information resource.

4. The means of claim 3, further comprising:
a request forwarding means of forwarding the request in the form of a referral from a vendor that has received the request and wherein those vendors able to advertise the solicited product or service can list that product or service with the Web server in exchange for compensation.

5. A system of displaying a plurality of electronic files, comprising:
a vendor database including information storage means for storing said plurality of electronic files, consisting of written documents, photographs, movies, spreadsheets, database reports, or any other electronic file that conveys information;
a marquee category file consisting of a plurality of phrases each associated with one of said plurality of electronic files;
a first display, or marquee display, displaying said marquee category file on an electronic screen so that said plurality of phrases move so that more than can fit within said marquee display can be viewed;
a means of indicating any one of the plurality of phrases in the marquee display;
a second display, or grid display, for the presentation in a comparison format any one of said plurality of electronic files selected by said means of indicating any one of the plurality of phrases in the marquee display; and
a means of presenting in said grid display, in a comparison format, the information in any one of said multiplicity of electronic files,
whereby a person can review listings of information, such as categories of internal company of government entity phone numbers, or desired products or services on a common local area network or on the Internet without leaving the home page of any Web site that uses the present system.

6. The system of claim 5, further comprising a means of minimizing the experience of the server round trip, after the first server round trip, when the means of indicating any one of the plurality of phrases in the marquee display results in said information file being presented on said electronic screen by any means, such as by using threads of a Java applet.

7. The system of claim 5, further comprising providing the vendor database for files from vendors that either do or do not have a Web presence.

8. The system of claim 5, further comprising a request for products or services not found made by a client, wherein said request for products or services not found is transmitted to those vendors that have agreed to receive the request in the form of a solicitation from a Web server, and wherein those vendors able to advertise the solicited product or service can list that product or service with said Web server in exchange for compensation or, in the case of a local area network, without compensation.

9. The system of claim 5, further comprising a request for products or services not found forwarding means of forwarding the request for products or services not found in the form of a referral from a vendor that has received the request for products or services not found and wherein those vendors able to advertise the solicited product or service can list that product or service with said Web server in exchange for compensation.
